(19) United States
(12) Patent Application Publication
(10) Pub. No.: US 2025/0162213 A1
(43) Pub. Date: May 22, 2025

(54) INJECTION DEVICE FOR FOAM MOLDING, INJECTION MOLDING MACHINE, AND MATERIAL SUPPLYING METHOD

(71) Applicant: THE JAPAN STEEL WORKS, LTD, Tokyo (JP)

(72) Inventors: Yuki KAJIWARA, Tokyo (JP); Akihiro NAITO, Tokyo (JP)

(21) Appl. No.: 18/948,018

(22) Filed: Nov. 14, 2024

(30) Foreign Application Priority Data
Nov. 21, 2023 (JP) 2023-197112

(51) Int. Cl. B29C 44/38; B29C 44/02; B29C 44/34; B29C 44/60

(52) U.S. Cl. CPC B29C 44/38; B29C 44/02; B29C 44/3415; B29C 44/3446; B29C 44/60

(57) ABSTRACT

An injection device includes a heating cylinder, a screw, a material supply device supplying a material to a material supply port of the heating cylinder, and a gas supply device supplying gas to the heating cylinder. The gas supply device is connected to a central gas supply port provided in the heating cylinder and to a material supply side gas supply port provided in the material supply port. The material supply device includes a material storage portion configured to store a material, and a pressure regulating buffer portion configured to store the material from the material storage portion and to supply the stored material to the material supply port, and which includes a first valve on a side near the material storage portion and a second valve on a side near the material supply port.

### CROSS-REFERENCE TO RELATED APPLICATIONS

This application is based on and claims priority under 35 USC 119 from Japanese Patent Application No. 2023-197112 filed on Nov. 21, 2023, the entire content of which is incorporated herein by reference.

### TECHNICAL FIELD

The present disclosure relates to an injection device that injects a gas into an injection material to mold a foam molded article, an injection molding machine including such an injection device, and a material supplying method for supplying a material to an injection device.

### BACKGROUND

An injection molding machine for molding a foam molded article using so-called inert gases such as nitrogen gas or carbon dioxide gas as a physical foaming agent is configured as follows, for example. First, an injection device of an injection molding machine includes a heating cylinder and a screw, and the heating cylinder has a plurality of zones according to the shape of the screw. That is, there are an upstream plasticization zone where a resin is plasticized, a gas supply zone into which a gas is supplied downstream of the plasticization zone, and a kneading and compression zone where the resin is kneaded and compressed together with the gas downstream of the gas supply zone. A predetermined amount of the resin that is kneaded and compressed with the gas is metered, and the metered amount of resin is injected into a mold. This causes the gas to foam within the mold to obtain a foam molded article.

JP2023-118318A discloses an injection device to which a gas is supplied to obtain a foam molded article. The injection device is also supplied with the gas near the center of the heating cylinder, that is, in the gas supply zone, but the gas may also be supplied from other locations. Specifically, the gas is also supplied from a material supply port through which a material is supplied to the heating cylinder. According to the injection device described in JP2023-118318A, since the gas is also supplied from the material supply port, it is possible to prevent the gas supplied from the gas supply zone in the heating cylinder from flowing back inside the heating cylinder.

### SUMMARY

According to the injection device described in JP2023-118318A, since the gas is also supplied from the material supply port, backflow of the gas within the heating cylinder may be prevented. However, there is also a problem to be solved. Specifically, the pressure of the gas supplied from the material supply port hinders the material from dropping from a hopper. If the material does not fall smoothly, the supply of the material from the material supply port becomes unstable, which affects the quality of the obtained molded article.

The present disclosure provides an injection device in which a gas is also supplied from a material supply port, backflow of the gas is prevented, and a material can be smoothly supplied while maintaining a constant pressure inside a heating cylinder.

Other problems and novel features will become apparent from description of the present description and the accompanying drawings.

The present disclosure relates to an injection device having a following configuration. That is, an injection device includes: a heating cylinder; a screw provided in the heating cylinder; a material supply device configured to supply a material to a material supply port formed in the heating cylinder; and a gas supply device configured to supply a gas that is a physical foaming agent to the heating cylinder. The gas supply device is connected to a central gas supply port provided in the vicinity of a center of the heating cylinder and to a material supply side gas supply port provided in the vicinity of the material supply port. The material supply device includes a material storage portion configured to store a material and a pressure regulating buffer portion. The pressure regulating buffer portion is configured to store a predetermined amount of the material from the material storage portion and supply the stored material to the material supply port. The pressure regulating buffer portion includes a first valve on a side near the material storage portion and a second valve on a side near the material supply port.

According to the present disclosure, the material is smoothly supplied to the heating cylinder.

### BRIEF DESCRIPTION OF DRAWINGS

FIG. 1 is a front view showing an injection molding machine according to a first illustrative embodiment.

FIG. 2 is a front sectional view showing an injection device according to the first illustrative embodiment.

FIG. 3 is a flowchart showing a material supplying method according to the first illustrative embodiment.

FIG. 4A is a front sectional view showing the injection device according to the first illustrative embodiment.

FIG. 4B is a front sectional view showing the injection device according to the first illustrative embodiment.

FIG. 4C is a front sectional view showing the injection device according to the first illustrative embodiment.

FIG. 4D is a front sectional view showing the injection device according to the first illustrative embodiment.

FIG. 5 is a front sectional view showing an injection device according to a modification of the first illustrative embodiment.

FIG. 6 is a flowchart showing a material supplying method according to a modification of the first illustrative embodiment.

FIG. 7 is a front sectional view showing an injection device according to a second illustrative embodiment.

FIG. 8 is a flowchart showing a material supplying method according to the second illustrative embodiment.

### DETAILED DESCRIPTION

Hereinafter, specific illustrative embodiments will be described in detail with reference to the drawings. The present disclosure is not limited to the following illustrative embodiments. In order to clarify the description, the following description and the drawings are simplified as appropriate. In the drawings, the same elements are denoted by the same reference numerals, and repeated description thereof is omitted as necessary. In addition, hatching may be omitted to avoid complicating the drawings.

### First Illustrative Embodiment

### {Injection Molding Machine}

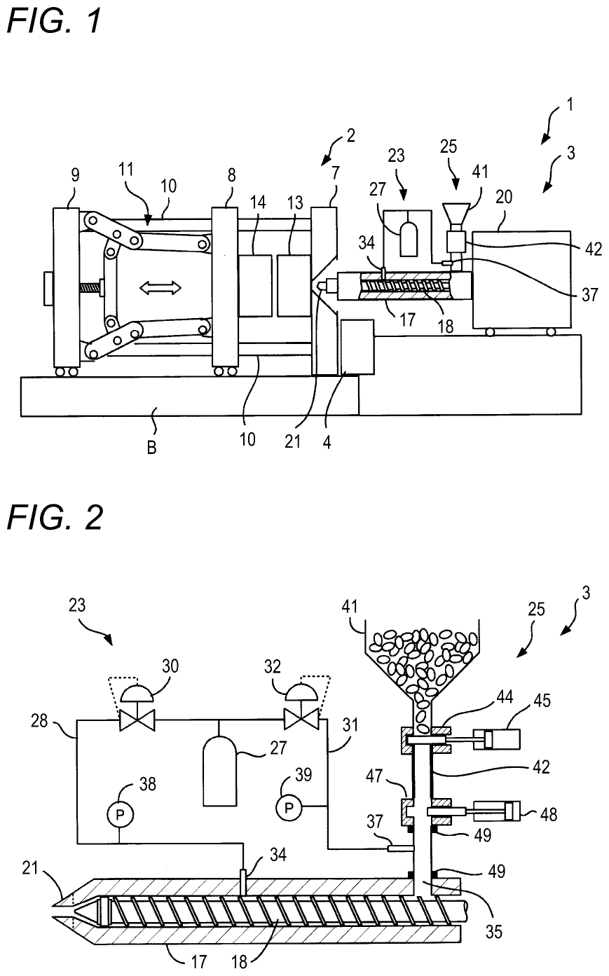

As shown in FIG. 1, an injection molding machine 1 according to a first illustrative

embodiment generally includes a mold clamping device 2, an injection device 3 provided on a bed B and a control device 4 configured to control the injection molding machine 1, including the mold clamping device 2 and the injection device 3, also referred to as a control unit.

### {Mold Clamping Device}

The mold clamping device 2 may be of a direct pressure type. In the present illustrative embodiment, the mold clamping device 2 is of a toggle type. The mold clamping device 2 includes a fixed platen 7 fixed to the bed B, a movable platen 8 slidably provided on the bed B, and a mold clamping housing 9 also slidably provided on the bed B. The fixed platen 7 and the mold clamping housing 9 are coupled by a plurality of tie bars 10, 10, . . . . The movable platen 8 is disposed between the fixed platen 7 and the mold clamping housing 9. A toggle mechanism 11 is provided between the movable platen 8 and the mold clamping housing 9. The fixed platen 7 and the movable platen 8 of the mold clamping device 2 are provided with a fixed mold 13 and a movable mold 14, respectively. When the toggle mechanism 11 is driven, the molds 13 and 14 are clamped. Alternatively, the molds are opened and closed.

### {Injection Device}

The injection device 3 includes a heating cylinder 17, a screw 18 placed in the heating cylinder 17, a screw driving device 20 that supports the heating cylinder 17 and is configured to drive the screw 18, and an injection nozzle 21 provided at a tip end of the heating cylinder 17. The injection device 3 according to the first illustrative embodiment further includes a gas supply device 23 configured to supply a gas that is a physical foaming agent, and a material supply device 25 configured to supply a material, that is, resin pellets, to the heating cylinder 17.

### {Gas Supply Device}

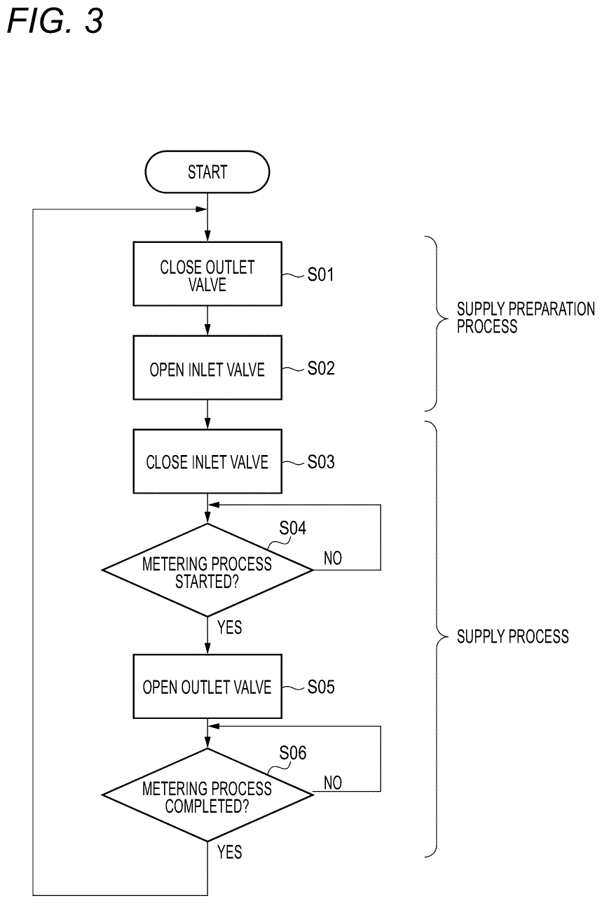

FIG. 2 is an enlarged view of the injection device 3. The gas supply device 23 according to the first illustrative embodiment will be described. The gas supply device 23 includes a cylinder 27, a first pressure reducing valve 30 provided in a first pipe 28 branched off from the cylinder 27, and a second pressure reducing valve 32 provided in a second pipe 31 branched in the same manner. The cylinder 27 holds a gas such as nitrogen gas or carbon dioxide gas, which is a physical foaming agent. The first pipe 28 is connected to a central gas supply port 34 provided in the vicinity of the center of the heating cylinder 17, and the second pipe 31 is connected to a material supply side gas supply port 37 provided in the vicinity of a material supply port 35 of the heating cylinder 17. The pipes 28 and 31 are provided with pressure gauges 38 and 39, respectively. The material supply side gas supply port 37 may be provided in the heating cylinder 17 as long as it is in the vicinity of the material supply port 35.

In the first illustrative embodiment, the pressure of the gas supplied to the material supply side gas supply port 37 is reduced so as to be lower than the pressure of the gas supplied to the central gas supply port 34. The gas supplied to the central gas supply port 34 is kept at a relatively high pressure since it is required to be efficiently supplied to the resin being kneaded in the injection device 3. On the other hand, the gas supplied to the material supply side gas supply port 37 is kept at a relatively low pressure just enough to prevent backflow of the gas in the heating cylinder 17. Further, as will be described later, a part of the gas supplied to the material supply side gas supply port 37 is exhausted to the atmosphere. Therefore, there is an advantage in that an amount of exhausted gas can be reduced by setting the pressure at a low level.

The pressures of the gas supplied to the central gas supply port 34 and the gas supplied to the material supply side gas supply port 37 may be equal to each other. In this case, although the amount of gas exhausted to the atmosphere is slightly increased, the entire device can be simplified. That is, the first pipe 28 and the second pipe 31 can be combined into one pipe, and the pressure reducing valves 30 and 32 and the pressure gauges 38 and 39 can be reduced to one each.

### {Material Supply Device}

As shown in FIG. 2, the material supply device 25 according to the first illustrative embodiment includes a material storage portion, that is, a hopper 41, in which the material is stored, and a pressure regulating buffer portion, that is, a pressure regulating container 42, which is configured to adjust an internal pressure. An upper portion of the pressure regulating container 42 is connected to a lower portion of the hopper 41, and a lower portion of the pressure regulating container 42 is connected to the material supply port 35 of the heating cylinder 17. A first valve, that is, an inlet valve 44 is provided between the pressure regulating container 42 and the hopper 41. When the inlet valve 44 is opened by an actuator 45, the material in the hopper 41 is allowed to flow into the pressure regulating container 42. A second valve, that is, an outlet valve 47 is provided between the pressure regulating container 42 and the material supply port 35. When the outlet valve 47 is opened by an actuator 48, the material in the pressure regulating container 42 is supplied or discharged to the material supply port 35.

In the first illustrative embodiment, the material for one or more molding cycles (that is, at least one molding cycle) is temporarily stored in the pressure regulating container 42. That is, the material of an amount that can be metered by one or more times in a metering process 30 performed in the injection device 3 can be stored. Therefore, as will be described later, in the metering process, it is sufficient to open and close the inlet valve 44 and the outlet valve 47 once each. However, an amount of the material temporarily stored in the pressure regulating container 42 may be reduced. In this case, it is necessary to open and close the inlet valve 44 and the outlet valve 47 a plurality of times each in one metering process.

In the material supply device 25, predetermined seal members 49, 49 such as O-rings are provided at a connection portion between the material supply port 35 and the pressure regulating container 42. Accordingly, airtightness between the pressure regulating container 42 and the material supply port 35 is maintained. When the first and second valves, that is, the inlet valve 44 and the outlet valve 47 are closed, the inside of the pressure regulating container 42 is kept airtight.

### {Material Supplying Method}

A material supplying method according to the first illustrative embodiment performed

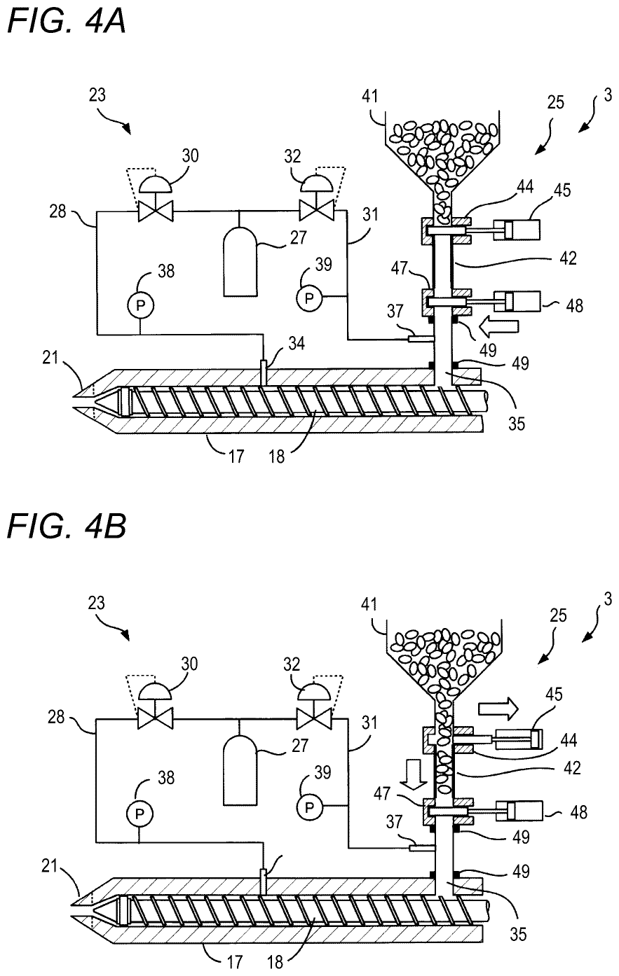

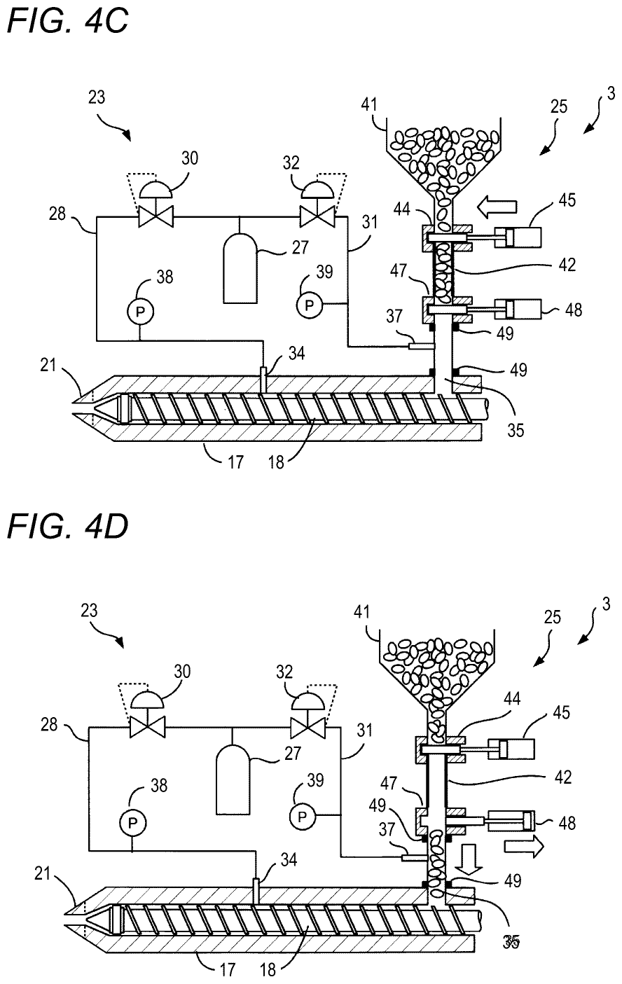

in the injection device 3 according to the first illustrative embodiment will be described. This material supplying method is performed in the control device 4 (see FIG. 1). First, a state where the first valve, that is, the inlet valve 44 (see FIG. 2) is closed will be described. The control device 4 performs step S01 shown in FIG. 3. That is, as shown in FIG. 4A, the actuator 48 is driven to close the second valve, that is, the outlet valve 47. This blocks the material supply port 35 of the heating cylinder 17 from the pressure regulating container 42. In this state, the pressure of the gas in the material supply port 35 is equal to that in the pressure regulating container 42. That is, the pressure regulating container 42 holds the gas at a predetermined pressure.

Next, the control device 4 (see FIG. 1) performs step S02 shown in FIG. 3. That is, as shown in FIG. 4B, the actuator 45 is driven to open the first valve, that is, the inlet valve 44. This allows the hopper 41 and the pressure regulating container 42 to communicate with each other. The inside of the hopper 41 is at atmospheric pressure, and the gas in the pressure regulating container 42 is instantly released toward the hopper 41. As a result, the inside of the pressure regulating container 42 is also at atmospheric pressure. Since the pressure in the pressure regulating container 42 is equal to the pressure in the hopper 41, the material in the hopper 41 smoothly falls into the pressure regulating container 42. Accordingly, a predetermined amount of material is temporarily stored in the pressure regulating container 42. Since the gas in the pressure regulating container 42 is released toward the hopper 41 in step S02, the gas is discharged from the hopper 41 to the outside and is discarded.

Next, the control device 4 (see FIG. 1) performs step S03 shown in FIG. 3. That is, as shown in FIG. 4C, the first valve, that is, the inlet valve 44 is closed. This blocks the pressure regulating container 42 from the hopper 41. At this time, the inside of the pressure regulating container 42 is atmospheric pressure. The control device 4 performs step S04 as shown in FIG. 3 to determine whether the metering process is started in the injection device 3. If the metering process is not started (NO), step S04 is repeated. On the other hand, if the metering process is started (YES), the process proceeds to step S05.

In step S05, as shown in FIG. 4D, the second valve, that is, the outlet valve 47 is opened. This allows the gas to flow instantly from the material supply port 35 to the pressure regulating container 42, and the pressure becomes equal. When the pressure becomes equal, the material stored in the pressure regulating container 42 smoothly falls into the material supply port 35. The control device 4 (see FIG. 1) performs the metering process in the injection device 3.

The control device 4 performs step S06 shown in FIG. 3 to determine whether the metering process is completed. If the metering process is not completed (NO), step S06 is repeated. On the other hand, if the metering process is completed (YES), the process returns to step S01. The same is repeated thereafter. Step S01 and step S02 are preparation processes for supplying the material to the material supply port 35 (see FIG. 2), and therefore can be referred to as a supply preparation process. On the other hand, steps S03 to S06 can be referred to as a supply process since the material is actually supplied to the material supply port 35.

### {Modification of First Illustrative Embodiment}

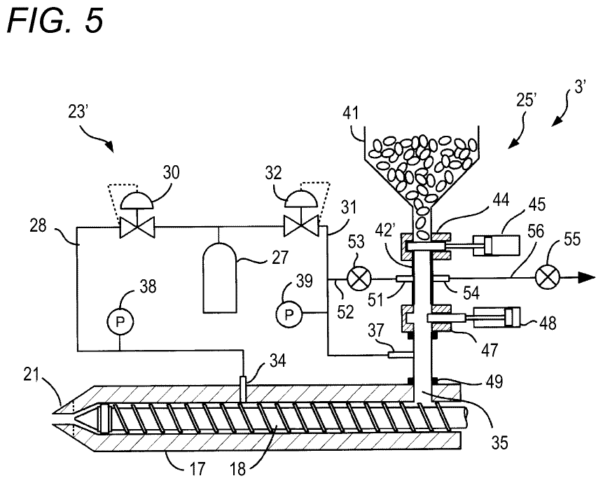

The first illustrative embodiment may be modified in various ways, and FIG. 5 shows an injection device 3′ according to a modification. The same members as those of the first illustrative embodiment are denoted by the same reference numerals, and description thereof is omitted. In the injection device 3′ according to the modification of the first illustrative embodiment, a gas supply device 23′ and a material supply device 25′ are modified. First, a pressure regulating container 42′ of the material supply device 25′ is provided with a buffer portion side gas supply device (also referred to as buffer-side gas supply device) 51 to which gas is supplied. The second pipe 31 of the gas supply device 23′ is branched, and a pipe 52 formed by branching is provided with a gas supply valve 53 and is connected to the buffer portion side gas supply device 51. Further, the pressure regulating container 42′ has an exhaust portion 54, and an exhaust pipe 56 provided with a relief valve 55 is connected to the exhaust portion 54.

### {Modification of Material Supplying Method}

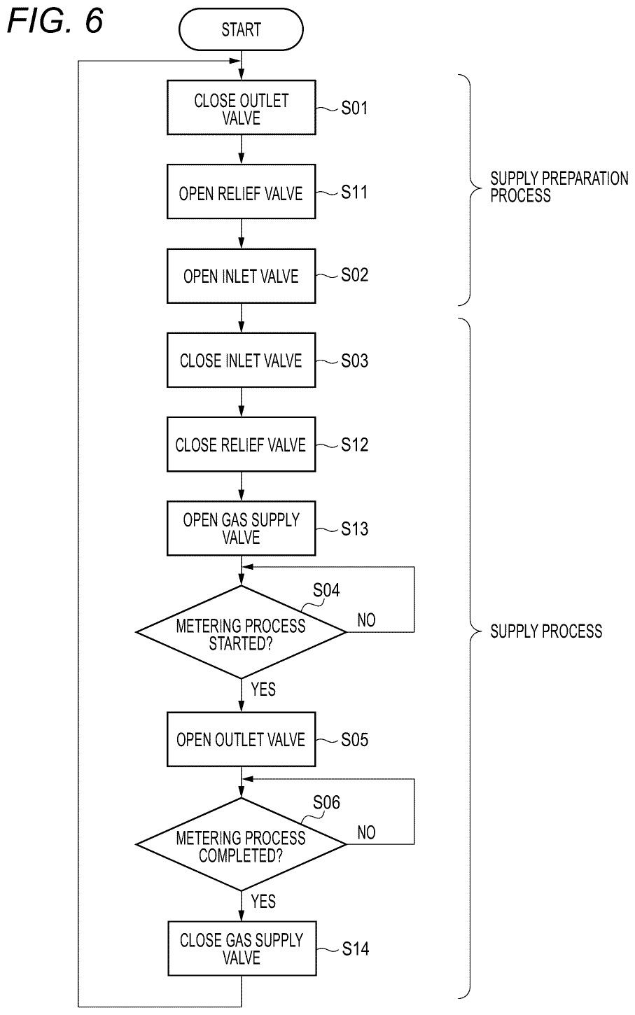

A material supplying method according to the modification implemented in the injection device 3′ according to the modification of the first illustrative embodiment will be described with reference to FIG. 6. The material supplying method according to the modification has some processes (steps S01, S02, . . . ) similar to those of the material supplying method according to the first illustrative embodiment shown in FIG. 3. Therefore, the explanation of the similar processes will be simplified, and modified processes will be explained in detail.

In the material supplying method according to the modification, the first valve, that is, the inlet valve 44 is also closed at first. First, as shown in FIG. 6, step S01 is performed, and the control device 4 (see FIG. 1) closes the second valve, that is, the outlet valve 47. The control device 4 (see FIG. 1) opens the relief valve 55 (see FIG. 5) in step S11. This allows the gas to be discharged from the inside of the pressure regulating container 42′, and the inside of the pressure regulating container 42′ becomes the atmospheric pressure. Subsequently, when the control device 4 opens the inlet valve 44 in step S02, the material in the hopper 41 falls smoothly into the pressure regulating container 42′ since there is no pressure difference.

The control device 4 (see FIG. 1) closes the inlet valve 44 (see FIG. 5) in step S03 (see FIG. 6). Next, step S12 is performed to close the relief valve 55. This brings the pressure regulating container 42′ into a sealed state. The control device 4 performs step S13. That is, the gas supply valve 53 is opened. This allows the gas to be supplied to the pressure regulating container 42′, and the pressure inside the container 42′ becomes equal to that of the material supply port 35. Whether the metering process is started is determined in step S04, and when the metering process is started (YES), the outlet valve 47 is opened in step S05. This allows the material in the pressure regulating container 42′ to fall down smoothly and be supplied to the material supply port 35 since there is no pressure difference between the pressure regulating container 42′ and the material supply port 35. When it is determined that the metering process is completed in step S06 (YES), step S14 is performed. That is, the gas supply valve 53 is closed. The process returns to step S01.

### Second Illustrative Embodiment

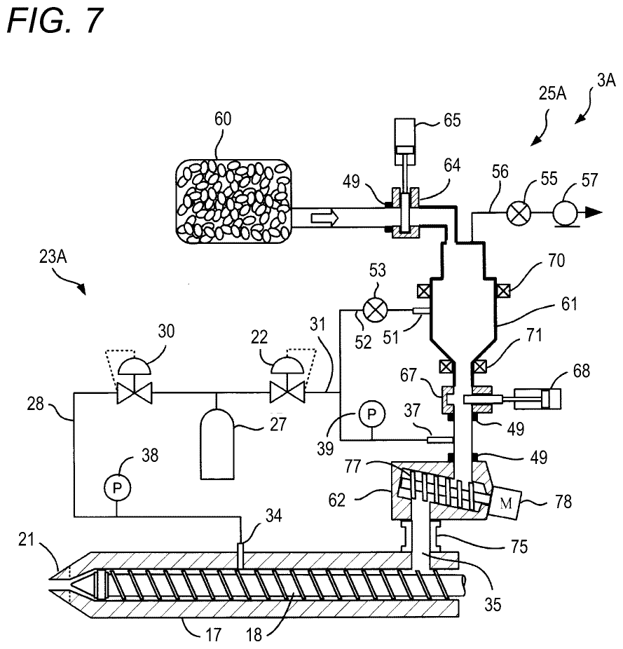

A second illustrative embodiment will be described. Except for an injection device 3A shown in FIG. 7, the mold clamping device and the like of an injection molding machine according to the second illustrative embodiment is configured in the same manner as the injection molding machine 1 (see FIG. 1) according to the first illustrative embodiment.

Description of the same configuration is omitted. In the injection device 3A according to the second illustrative embodiment, the same configurations as those of the injection device 3 (see FIG. 2) according to the first illustrative embodiment or the same configurations as those of the injection device 3′ (see FIG. 5) according to the modification of the first illustrative embodiment are denoted by the same reference numerals, and the description thereof will be omitted.

The injection device 3A according to the second illustrative embodiment is different from that in the first illustrative embodiment in a material supply device 25A. The material supply device 25A includes a material storage portion, that is, a material tank 60 containing a relatively large amount of material, a pressure regulating buffer portion, that is, a pressure regulating hopper 61 having a relatively large capacity, and a quantitative feeder 62 for accurately feeding the material.

A first valve, that is, a receiving valve 64 is provided between the material tank 60 and the pressure regulating hopper 61, and is opened and closed by an actuator 65. A second valve, that is, a discharge valve 67 is provided between the pressure regulating hopper 61 and the quantitative feeder 62, and is opened and closed by an actuator 68. When the discharge valve 67 is opened, the material stored in the pressure regulating hopper 61 is supplied or discharged to the quantitative feeder 62. In this illustrative embodiment, the pressure regulating hopper 61 is designed to store the material for a plurality of molding cycles.

The pressure regulating hopper 61 is provided with the buffer portion side gas supply device 51, and a gas is supplied from a pipe 52 branched from the second pipe 31 of the gas supply device 23A through the gas supply valve 53. The pressure regulating hopper 61 is provided with the exhaust pipe 56, and the exhaust pipe 56 is provided with the relief valve 55 and a suction pump 57. As will become clear from the material supplying method described later, the pressure regulating hopper 61, the receiving valve 64, and the discharge valve 67 in the second illustrative embodiment are similar to the pressure regulating container 42′ (see FIG. 5), the inlet valve 44, and the outlet valve 47 in the modification of the first illustrative embodiment, respectively. That is, the same operation is achieved. The pressure regulating hopper 61 has an upper limit sensor 70 for detecting that the material stored therein reaches an upper limit and a lower limit sensor 71 for detecting that the material stored therein reaches a lower limit.

The quantitative feeder 62 is connected to the material supply port 35 via a spacer 75, and has a material delivery screw 77 therein for delivering the material. The material delivery screw 77 is rotated by a motor 78. The quantitative feeder 62 has a predetermined capacity and is configured to hold the material for one molding cycle or more.

In the second illustrative embodiment, the material supply side gas supply port 37 is provided between the pressure regulating hopper 61 and the quantitative feeder 62. Since the gas is supplied from this position, the pressure of the gas from the quantitative feeder 62 to the material supply port 35 becomes uniform.

### {Material Supplying Method}

In the injection device 3A according to the second illustrative embodiment, the material is supplied to the material supply port 35 of the heating cylinder 17 by the quantitative feeder 62. The quantitative feeder 62 is driven by the control device 4 (see FIG. 1) in synchronization with the metering process of the molding cycle. On the other hand, it is not necessary to synchronize the supply or discharge of the material from the pressure regulating hopper 61 to the quantitative feeder 62 with the molding cycle, and the material is supplied asynchronously. A method of supplying a material to the quantitative feeder 62 will be described as a material supplying method according to the second illustrative embodiment. As described above, since the quantitative feeder 62 holds the material for one molding cycle or more, no problem occurs even if the supply of the material from the pressure regulating hopper 61 to the quantitative feeder 62 is asynchronous with the molding cycle.

To describe the material supplying method according to the second illustrative embodiment, initially, the first valve, that is, the receiving valve 64 is closed, and the second valve, that is, the discharge valve 67 is opened. Then, the gas is supplied from the buffer portion side gas supply device 51 to the pressure regulating hopper 61. In this state, the material in the pressure regulating hopper 61 is freely supplied or discharged to the material supply port 35 side, that is, the quantitative feeder 62 side.

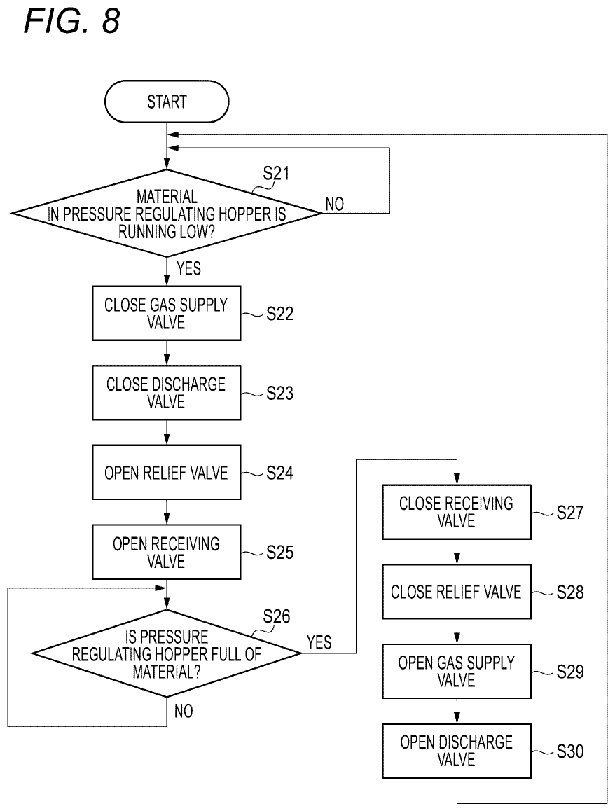

In the material supplying method according to the second illustrative embodiment, first, as shown in FIG. 8, the control device 4 (see FIG. 1) performs step S21. That is, the lower limit sensor 71 detects whether the material in the pressure regulating hopper 61 (see FIG. 7) is running low. If there is still material available (NO), step S21 is repeated. On the other hand, when the material reaches the lower limit (YES), the process proceeds to step S22. The control device 4 closes the gas supply valve 53 in step S22. Accordingly, the supply of the gas to the pressure regulating hopper 61 is stopped. Next, step S23 is performed to close the second valve, that is, the discharge valve 67. Accordingly, the material supply from the pressure regulating hopper 61 to the quantitative feeder 62 is stopped. The control device 4 opens the relief valve 55 in step S24. This allows the gas in the pressure regulating hopper 61 to be exhausted, and the pressure inside the pressure regulating hopper 61 becomes atmospheric pressure.

The control device 4 (see FIG. 1) performs step S25. The first valve, that is, the receiving valve 64 is opened. Then, the suction pump 57 is driven. Then, the material is sucked from the material tank 60 and is supplied to the pressure regulating hopper 61. Air enters the pressure regulating hopper 61 together with the material, and the air is discharged to the outside through the relief valve 55 and the suction pump 57. That is, only the material is stored in the pressure regulating hopper 61. The control device 4 executes step S26 and determines whether the stored material reaches the upper limit by the upper limit sensor 70. In a case where the upper limit is not yet reached (NO), step S26 is repeated. On the other hand, in a case where the upper limit is reached (YES), the process proceeds to step S27.

The control device 4 (see FIG. 1) performs step S27 to close the receiving valve 64. Further, the suction pump 57 is stopped. This stops the supply of the material from the material tank 60. Subsequently, the control device 4 performs step S28 to close the relief valve 55. This brings the pressure regulating hopper 61 into a sealed state. The control device 4 opens the gas supply valve 53 in step S29. The gas is supplied into the pressure regulating hopper 61, and the pressure of the gas becomes equal to that in the material supply port 35. The control device 4 performs step S30 to open the second valve, that is, the discharge valve 67. That is, the supply of the material from the pressure regulating hopper 61 to the quantitative feeder 62 is restarted. The process returns to step S21.

Although the invention made by the present inventors is specifically described based on the illustrative embodiments, it is needless to say that the present invention is not limited to the illustrative embodiments described above, and various modifications can be made without departing from the scope of the invention. The plurality of examples described above may be appropriately combined.

What is claimed is:

1. An injection device comprising:
a heating cylinder;
a screw provided in the heating cylinder;
a material supply device configured to supply a material to a material supply port formed in the heating cylinder; and
a gas supply device configured to supply a gas that is a physical foaming agent to the heating cylinder,
wherein the gas supply device is connected to a central gas supply port provided in the vicinity of a center of the heating cylinder and to a material supply side gas supply port provided in the vicinity of the material supply port,
wherein the material supply device includes:
a material storage portion configured to store a material; and
a pressure regulating buffer portion,
wherein the pressure regulating buffer portion is configured to store a predetermined amount of the material from the material storage portion and supply the stored material to the material supply port, and
wherein the pressure regulating buffer portion includes:
a first valve on a side near the material storage portion; and
a second valve on a side near the material supply port.

2. The injection device according to claim 1, further comprising:
a control device,
wherein the control device is configured to execute supply preparation processing and supply processing,
wherein the supply preparation processing includes closing the second valve and then opening the first valve to allow the material from the material storage portion to be stored in the pressure regulating buffer portion, and
wherein the supply processing includes closing the first valve and then opening the second valve to allow the material stored in the pressure regulating buffer portion to be supplied to the material supply port.

3. The injection device according to claim 1,
wherein the pressure regulating buffer portion and the material supply port are connected to via a predetermined seal member to maintain airtightness.

4. The injection device according to claim 1,
wherein the pressure regulating buffer portion is configured to store an amount of the material sufficient for at least one molding cycle.

5. The injection device according to claim 1,
wherein the pressure regulating buffer portion includes a sensor configured to detect whether the material in the pressure regulating buffer portion has reached a lower limit.

6. The injection device according to claim 1,
wherein the pressure regulating buffer portion includes a relief valve configured to release an internal pressure to atmospheric pressure.

7. The injection device according to claim 1,
wherein the pressure regulating buffer portion includes a buffer-side gas supply device, and
wherein the gas supply device is connected to the buffer-side gas supply device via a gas supply valve.

8. The injection device according to claim 1,
wherein a pressure of a gas supplied from the material supply side gas supply port is adjusted to be lower than a pressure of a gas supplied from the central gas supply port.

9. The injection device according to claim 1,
wherein the material storage portion includes a hopper.

10. The injection device according to claim 1,
wherein the material supply device includes a quantitative feeder that is provided between the pressure regulating buffer portion and the material supply port.

11. The injection device according to claim 10,
wherein the quantitative feeder has a capacity to hold an amount of the material sufficient for at least one molding cycle.

12. An injection molding machine comprising:
an injection device configured to inject a resin; and
a mold clamping device configured to clamp a mold,
wherein the injection device includes:
a heating cylinder;
a screw provided in the heating cylinder;
a material supply device configured to supply a material to a material supply port formed in the heating cylinder; and
a gas supply device configured to supply a gas, which is a physical foaming agent, to the heating cylinder,
wherein the gas supply device is connected to a central gas supply port provided in the vicinity of a center of the heating cylinder and to a material supply side gas supply port provided in the vicinity of the material supply port,
wherein the material supply device includes:
a material storage portion configured to store a material; and
a pressure regulating buffer portion,
wherein the pressure regulating buffer portion is configured to store a predetermined amount of the material from the material storage portion and to supply the stored material to the material supply port, and
wherein the pressure regulating buffer portion includes:
a first valve on a side near the material storage portion; and
a second valve on a side near the material supply port.

13. The injection molding machine according to claim 12, further comprising:
a control device,
wherein the control device is configured to execute supply preparation processing and supply processing,
wherein the supply preparation processing includes closing the second valve and then opening the first valve to allow the material from the material storage portion to be temporarily stored in the pressure regulating buffer portion, and
wherein the supply processing includes closing the first valve and then opening the second valve allow the material stored in the pressure regulating buffer portion to be supplied to the material supply port.

14. The injection molding machine according to claim 12,
wherein the pressure regulating buffer portion and the material supply port are connected via a predetermined seal member to maintain airtightness.

15. A material supplying method performed in foam molding by an injection device,
the injection device including:
a heating cylinder;
a screw provided in the heating cylinder;
a material supply device configured to supply a material to a material supply port formed in the heating cylinder; and
a gas supply device configured to supply a gas, which is a physical foaming agent, to the heating cylinder,
the gas supply device being connected to a central gas supply port provided in the vicinity of a center of the heating cylinder and to a material supply side gas supply port provided in the vicinity of the material supply port,
the material supply device including a material storage portion configured to store a material, and a pressure regulating buffer portion configured to temporarily store a predetermined amount of the material, and
the pressure regulating buffer portion including a first valve on a side near the material storage portion, and a second valve on a side near the material supply port,
the material supplying method comprising:
a supply preparation process including closing the second valve and then opening the first valve to allow the material from the material storage portion to flow and be stored in the pressure regulating buffer portion; and
a supply process including closing the first valve and then opening the second valve to allow the material stored in the pressure regulating buffer portion to be supplied to the material supply port.

16. The material supplying method according to claim 15,
wherein the pressure regulating buffer portion includes a sensor configured to detect whether the material in the pressure regulating buffer portion reaches a lower limit, and
wherein the supply preparation process is performed based on the sensor detecting the lower limit of the material.

17. The material supplying method according to claim 15,
wherein the supply process is performed during a metering process of a molding cycle in the injection device, and
wherein the supply preparation process is performed during a process other than the metering process.

18. The material supplying method according to claim 15,
wherein the pressure regulating buffer portion is configured to temporarily store an amount of the material sufficient for at least one molding cycle.

19. The material supplying method according to claim 15,
wherein the pressure regulating buffer portion includes a relief valve configured to release an internal pressure to atmospheric pressure, and
wherein the supply preparation process involves closing the second valve, then opening the relief valve, followed by opening the first valve.

20. The material supplying method according to claim 15,
wherein the pressure regulating buffer portion includes a buffer-side gas supply device that is connected to the gas supply device via a gas supply valve, and
wherein the supply process involves closing the first valve, then opening the gas supply valve, followed by opening the second valve.

21. The material supplying method according to claim 20,
wherein in the injection device, a pressure of a gas supplied from the material supply side gas supply port is adjusted to be lower than a pressure of a gas supplied from the central gas supply port, and
wherein the gas supply valve is controlled to open such that a pressure of a gas supplied to the buffer-side gas supply device equals the pressure of the gas supplied from the material supply side gas supply port.
